(19) United States
(12) Patent Application Publication
(10) Pub. No.: US 2014/0285444 A1
(43) Pub. Date: Sep. 25, 2014

(54) Touch Sensing Having Increased Immunity to the Presence of a Fluid Layer

(71) Applicants: Bernard J. Hermes, Southampton (GB); Shou Huang, Southampton (GB)

(72) Inventors: Bernard J. Hermes, Southampton (GB); Shou Huang, Southampton (GB)

(21) Appl. No.: 13/848,988

(22) Filed: Mar. 22, 2013

(51) Int. Cl. G06F 3/041

(52) U.S. Cl. CPC G06F 3/041
USPC 345/173

(57) ABSTRACT

In certain embodiments, a touch sensitive device includes a cover panel, a plurality of drive electrodes positioned below the cover panel, a plurality of sense electrodes positioned below the cover panel, and a controller. The controller includes a signal generator operable to supply a drive signal to a particular drive electrode of the plurality of drive electrodes. The controller further includes measurement circuits associated with each of the plurality of sense electrodes, each measurement circuit being operable to generate a signal corresponding to the charge transfer between the particular drive electrode and a corresponding sense electrode. The drive signal supplied by the signal generator has a frequency that reduces the charge transfer caused by a fluid layer located on the cover panel to an amount falling below a threshold corresponding to the point at which the controller determines that a touch is present.

### TECHNICAL FIELD

This disclosure generally relates to touch sensing systems.

### BACKGROUND

A touch sensing system may detect the presence and location of a touch or the proximity of an object (such as a user's finger or a stylus) within a touch-sensitive area of the touch sensor overlaid on a display screen, for example. In a touch sensitive display application, the touch sensor may enable a user to interact directly with what is displayed on the screen, rather than indirectly with a mouse or touch pad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are a number of different types of touch sensors, for example, resistive touch screens, surface acoustic wave touch screens, and capacitive touch screens. Herein, reference to a touch sensor may encompass a touch screen, and vice versa, where appropriate. When an object touches or comes within proximity of the surface of the capacitive touch screen, a change in capacitance may occur within the touch screen at the location of the touch or proximity. A touch-sensor controller may process the change in capacitance to determine its position on the touch screen.

### BRIEF DESCRIPTION OF THE DRAWINGS

FIG. 1 illustrates a touch sensor and touch sensor controller, according to certain embodiments of the present disclosure;

FIGS. 2A-2C illustrate the effect of the presence of water on a cover panel of a conventional touch sensor;

FIG. 3 illustrates the dependence of the polarization of water on applied frequency; and

FIG. 4 illustrates an example touch sensor having increased immunity to the presence of a fluid layer, according to certain embodiments of the present disclosure.

### DESCRIPTION OF EXAMPLE EMBODIMENTS

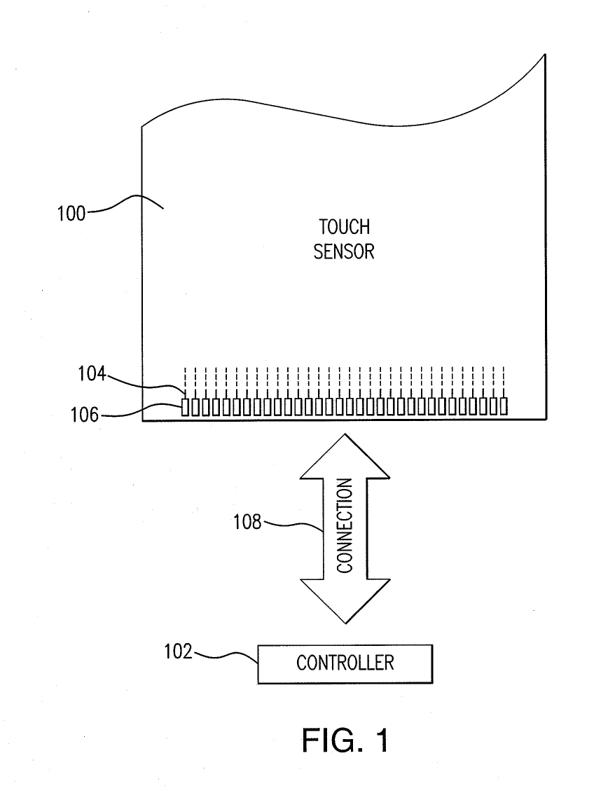

FIG. 1 illustrates a touch sensor 100 and touch sensor controller 102, according to certain embodiments of the present disclosure. Touch sensor 100 and touch-sensor controller 102 may detect the presence and location of a touch or the proximity of an object within a touch-sensitive area of touch sensor 100. Herein, reference to a touch sensor may encompass both the touch sensor and its touch-sensor controller, where appropriate. Similarly, reference to a touch-sensor controller may encompass both the controller and its touch sensor, where appropriate. Touch sensor 100 may include one or more touch-sensitive areas, where appropriate. Touch sensor 100 may include an array of drive and sense electrodes or an array of electrodes of a single type disposed on one or more substrates, which may be made of differing dielectric materials. Herein, reference to a touch sensor may encompass both the electrodes of the touch sensor and the substrate(s) that they are disposed on, where appropriate. Alternatively, where appropriate, reference to a touch sensor may encompass the electrodes of the touch sensor, but not the substrate(s) that they are disposed on.

An electrode (whether a drive electrode or a sense electrode) may be an area of conductive material forming a shape, such as for example a disc, square, rectangle, quadrilateral, other suitable shape, or suitable combination of these shapes. One or more cuts in one or more layers of conductive material may (at least in part) create the shape of an electrode, and the area of the shape may (at least in part) be bounded by those cuts. In certain embodiments, the conductive material of an electrode may occupy approximately 100% of the area of its shape. As an example and not by way of limitation, an electrode may be made of indium tin oxide (ITO) and the ITO of the electrode may occupy approximately 100% of the area of its shape, where appropriate. In certain embodiments, the conductive material of an electrode may occupy substantially less than 100% (such as for example, approximately 5%) of the area of its shape. As an example and not by way of limitation, an electrode may be made of fine lines of metal or other conductive material (such as for example copper, silver, or a copper- or silver-based material) and the fine lines of conductive material may occupy substantially less than 100% (such as for example, approximately 5%) of the area of its shape in a hatched, mesh, or other suitable pattern. Although this disclosure describes or illustrates particular electrodes made of particular conductive material forming particular shapes with particular fills having particular patterns, this disclosure contemplates any suitable electrodes made of any suitable conductive material forming any suitable shapes with any suitable fills having any suitable patterns. Where appropriate, the shapes of the electrodes (or other elements) of a touch sensor may constitute in whole or in part one or more macro-features of the touch sensor. One or more macro-features of a touch sensor may determine one or more characteristics of its functionality. One or more characteristics of the implementation of those shapes (such as, for example, the conductive materials, fills, or patterns within the shapes) may constitute in whole or in part one or more micro-features of the touch sensor. One or more micro-features of the touch sensor may determine one or more optical features of the touch sensor, such as transmittance, refraction, or reflection.

A mechanical stack may contain the substrate (or multiple substrates) and the conductive material forming the drive or sense electrodes of touch sensor 100. As an example and not by way of limitation, the mechanical stack may include a first layer of optically clear adhesive (OCA) beneath a cover panel. The cover panel may be clear and made of a resilient material suitable for repeated touching, such as for example glass, polycarbonate, or poly(methyl methacrylate) (PMMA). This disclosure contemplates any suitable cover panel made of any suitable material. The first layer of optically clear adhesive may be disposed between the cover panel and the substrate with the conductive material forming the drive or sense electrodes. The mechanical stack may also include a second layer of optically clear adhesive and a dielectric layer (which may be made of PET or another suitable material, similar to the substrate with the conductive material forming the drive or sense electrodes). As an alternative, where appropriate, a thin coating of a dielectric material may be applied instead of the second layer of optically clear adhesive and the dielectric layer. The second layer of optically clear adhesive may be disposed between the substrate with the conductive material making up the drive or sense electrodes and the dielectric layer, and the dielectric layer may be disposed between the second layer of optically clear adhesive and an air gap to a display of a device including touch sensor 100 and touch-sensor controller 102. As an example only and not by way of limitation, the cover panel may have a thickness of approximately 1 mm; the first layer of optically clear adhesive may have a thickness of approximately 0.05 mm; the substrate with the conductive material forming the drive or sense electrodes may have a thickness of approximately 0.05 mm; the second layer of optically clear adhesive may have a thickness of approximately 0.05 mm; and the dielectric layer may have a thickness of approximately 0.05 mm. Although this disclosure describes a particular mechanical stack with a particular number of particular layers made of particular materials and having particular thicknesses, this disclosure contemplates any suitable mechanical stack with any suitable number of any suitable layers made of any suitable materials and having any suitable thicknesses. As an example and not by way of limitation, in certain embodiments, a layer of adhesive or dielectric may replace the dielectric layer, second layer of optically clear adhesive, and air gap described above, with there being no air gap to the display.

One or more portions of the substrate of touch sensor 100 may be made of polyethylene terephthalate (PET) or another suitable material. This disclosure contemplates any suitable substrate with any suitable portions made of any suitable material. In certain embodiments, the drive or sense electrodes in touch sensor 100 may be made of ITO in whole or in part. In certain embodiments, the drive or sense electrodes in touch sensor 100 may be made of fine lines of metal or other conductive material. As an example and not by way of limitation, one or more portions of the conductive material may be copper or copper-based and have a thickness of approximately 5 μm or less and a width of approximately 10 μm or less. As another example, one or more portions of the conductive material may be silver or silver-based and similarly have a thickness of approximately 5 μm or less and a width of approximately 10 μm or less. This disclosure contemplates any suitable electrodes made of any suitable material.

Touch sensor 100 may implement a capacitive form of touch sensing. In a mutual-capacitance implementation, touch sensor 100 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitively coupled to each other across a space between them. A pulsed or alternating voltage applied to the drive electrode (by touch-sensor controller 102) may induce a charge on the sense electrode, and the amount of charge induced may be susceptible to external influence (such as a touch or the proximity of an object). When an object touches or comes within proximity of the capacitive node, a change in capacitance may occur at the capacitive node and touch-sensor controller 102 may measure the change in capacitance. By measuring changes in capacitance throughout the array, touch-sensor controller 102 may determine the position of the touch or proximity within the touch-sensitive area(s) of touch sensor 100.

In a self-capacitance implementation, touch sensor 100 may include an array of electrodes of a single type that may each form a capacitive node. When an object touches or comes within proximity of the capacitive node, a change in self-capacitance may occur at the capacitive node and touch-sensor controller 102 may measure the change in capacitance, for example, as a change in the amount of charge needed to raise the voltage at the capacitive node by a pre-determined amount. As with a mutual-capacitance implementation, by measuring changes in capacitance throughout the array, touch-sensor controller 102 may determine the position of the touch or proximity within the touch-sensitive area(s) of touch sensor 100. This disclosure contemplates any suitable form of capacitive touch sensing, where appropriate.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 100 may have drive and sense electrodes disposed in a pattern on one side of a single substrate. In such a configuration, a pair of drive and sense electrodes capacitively coupled to each other across a space between them may form a capacitive node. For a self-capacitance implementation, electrodes of only a single type may be disposed in a pattern on a single substrate. In addition or as an alternative to having drive and sense electrodes disposed in a pattern on one side of a single substrate, touch sensor 100 may have drive electrodes disposed in a pattern on one side of a substrate and sense electrodes disposed in a pattern on another side of the substrate. Moreover, touch sensor 100 may have drive electrodes disposed in a pattern on one side of one substrate and sense electrodes disposed in a pattern on one side of another substrate. In such configurations, an intersection of a drive electrode and a sense electrode may form a capacitive node. Such an intersection may be a location where the drive electrode and the sense electrode “cross” or come nearest each other in their respective planes. The drive and sense electrodes do not make electrical contact with each other—instead they are capacitively coupled to each other across a dielectric at the intersection. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 100 may indicate a touch or proximity input at the position of the capacitive node. Touch-sensor controller 102 may detect and process the change in capacitance to determine the presence and location of the touch or proximity input. Touch-sensor controller 102 may then communicate information about the touch or proximity input to one or more other components (such one or more central processing units (CPUs) or digital signal processors (DSPs)) of a device that includes touch sensor 100 and touch-sensor controller 102, which may respond to the touch or proximity input by initiating a function of the device (or an application running on the device) associated with it. Although this disclosure describes a particular touch-sensor controller having particular functionality with respect to a particular device and a particular touch sensor, this disclosure contemplates any suitable touch-sensor controller having any suitable functionality with respect to any suitable device and any suitable touch sensor.

Touch-sensor controller 102 may be one or more integrated circuits (ICs)—such as for example general-purpose microprocessors, microcontrollers, programmable logic devices or arrays, application-specific ICs (ASICs). In particular embodiments, touch-sensor controller 102 comprises analog circuitry, digital logic, and digital non-volatile memory. In particular embodiments, touch-sensor controller 102 is disposed on a flexible printed circuit (FPC) bonded to the substrate of touch sensor 100, as described below. In particular embodiments, multiple touch-sensor controllers 102 are disposed on the FPC. In some embodiments, the FPC may have no touch-sensor controllers 102 disposed on it. The FPC may couple touch sensor 100 to a touch-sensor controller 102 located elsewhere, such as for example, on a printed circuit board of the device. Touch-sensor controller 102 may include a processor unit, a drive unit, a sense unit, and a storage unit. The drive unit may supply drive signals to the drive electrodes of touch sensor 100. The sense unit may sense charge at the capacitive nodes of touch sensor 100 and provide measurement signals to the processor unit representing capacitances at the capacitive nodes. The processor unit may control the supply of drive signals to the drive electrodes by the drive unit and process measurement signals from the sense unit to detect and process the presence and location of a touch or proximity input within the touch-sensitive area(s) of touch sensor 100. The processor unit may also track changes in the position of a touch or proximity input within the touch-sensitive area(s) of touch sensor 100. The storage unit may store programming for execution by the processor unit, including programming for controlling the drive unit to supply drive signals to the drive electrodes, programming for processing measurement signals from the sense unit, and other suitable programming, where appropriate. Although this disclosure describes a particular touch-sensor controller having a particular implementation with particular components, this disclosure contemplates any suitable touch-sensor controller having any suitable implementation with any suitable components.

Tracks 104 of conductive material disposed on the substrate of touch sensor 100 may couple the drive or sense electrodes of touch sensor 100 to connection pads 106, also disposed on the substrate of touch sensor 100. As described below, connection pads 106 facilitate coupling of tracks 104 to touch-sensor controller 102. Tracks 104 may extend into or around (e.g. at the edges of) the touch-sensitive area(s) of touch sensor 100. Particular tracks 104 may provide drive connections for coupling touch-sensor controller 102 to drive electrodes of touch sensor 100, through which the drive unit of touch-sensor controller 102 may supply drive signals to the drive electrodes. Other tracks 104 may provide sense connections for coupling touch-sensor controller 102 to sense electrodes of touch sensor 100, through which the sense unit of touch-sensor controller 102 may sense charge at the capacitive nodes of touch sensor 100. Tracks 104 may be made of fine lines of metal or other conductive material. As an example and not by way of limitation, the conductive material of tracks 104 may be copper or copper-based and have a width of approximately 100 μm or less. As another example, the conductive material of tracks 104 may be silver or silver-based and have a width of approximately 100 μm or less. In particular embodiments, tracks 104 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 104, touch sensor 100 may include one or more ground lines terminating at a ground connector (which may be a connection pad 106) at an edge of the substrate of touch sensor 100 (similar to tracks 104).

Connection pads 106 may be located along one or more edges of the substrate, outside the touch-sensitive area(s) of touch sensor 100. As described above, touch-sensor controller 102 may be on an FPC. Connection pads 106 may be made of the same material as tracks 104 and may be bonded to the FPC using an anisotropic conductive film (ACF). Connection 108 may include conductive lines on the FPC coupling touch-sensor controller 102 to connection pads 106, in turn coupling touch-sensor controller 102 to tracks 104 and to the drive or sense electrodes of touch sensor 100. In another embodiment, connection pads 106 may be connected to an electro-mechanical connector (such as a zero insertion force wire-to-board connector); in this embodiment, connection 108 may not need to include an FPC. This disclosure contemplates any suitable connection 108 between touch-sensor controller 102 and touch sensor 100.

In particular embodiments, touch sensor 100 may have a multi-layer configuration, with drive electrodes disposed in a pattern on one side of a substrate and sense electrodes disposed in a pattern on another side of the substrate. In such a configuration, a pair of drive and sense electrodes capacitively couple to each other at the intersection of a drive electrode and sense electrode. In particular embodiments, a multi-layer configuration of drive and sense electrodes may satisfy certain space and/or shape constraints with respect to the construction of touch sensor 100.

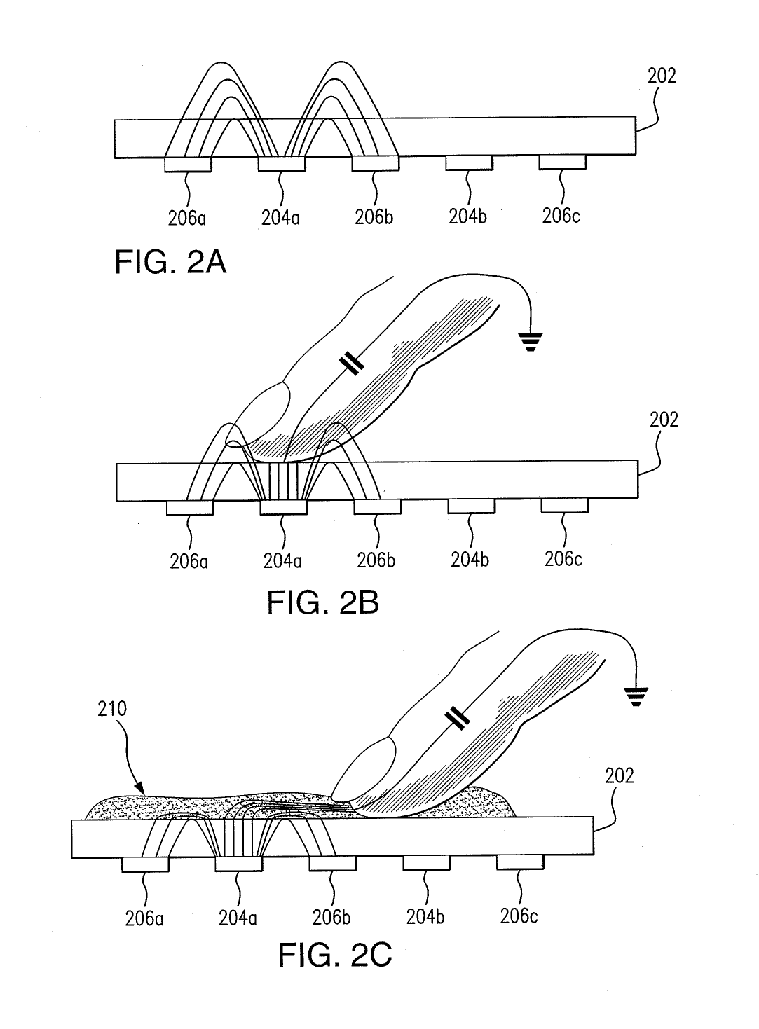

FIGS. 2A-2C illustrate the effect of the presence of water on a cover panel 202 of a conventional touch sensor 200. Touch sensor 200 may include a cover panel 202, drive electrodes 204, and sense electrodes 206. Although a particular arrangement of cover panel 202, drive electrodes 204, and sense electrodes 206 is depicted for illustrative purposes, the description of the effect of water provided below may be applicable to any suitable arrangement of the cover panel 202, drive electrodes 204, and sense electrodes 206.

As illustrated in FIG. 2A, the application of a drive signal to a drive electrode of touch sensor 200 (e.g., drive electrode 204a) may result in the generation of an electric field 208. In the absence of a touch, the generated electric field 208 may be measured by measurement circuitry (e.g., as a charge or a property related to charge, such as current or accumulated voltage) associated with one or more sense electrodes 206 of touch sensor 200 (e.g., sense electrodes 204a and 204b). In certain embodiments, an average baseline measurement (i.e., the measurement of electric field 208 in the absence of a touch) may be stored for each of the one or more sense electrodes 206 of touch sensor 200 (e.g., in a memory associated with a controller of touch sensor 200).

As illustrated in FIG. 2B, when a finger touch occurs on cover panel 202, a portion of the electric field 206 may be routed to ground (via the finger touching the cover panel 202), thereby bypassing the measurement circuitry associated with one or more sense electrodes 206 of touch sensor 200 (e.g., sense electrodes 204a and 204b). The result is that the charge transferred to sense electrodes 206 is reduced, and that reduction in charge transfer may be reflected in the measurements made by the measurement circuitry associated with sense electrodes 206 (e.g., sense electrodes 204a and 204b). Knowing the amount of the reduction in charge transfer and the measurement circuitry detecting that reduction may enable touch sensor 200 (or an associated controller) to determine the existence and location of a touch. In certain embodiments, the measurement circuitry associated with a particular sense electrode 206 may determine the presence of a touch by determining whether a current measurement associated with the generated electric field 208 differs from a stored baseline measurement for the particular sense electrode by more than a threshold amount.

As illustrated in FIG. 2C, however, the presence of a fluid layer 210 on cover panel 202 (e.g., a layer of water or any other electrically active fluid) may affect the above-described touch detection. For example, the generated electric field 208 may be concentrated and guided within the dielectric medium of the fluid layer 210, thereby effectively extending the area of the touch. As a result, a touch positioned between sense electrodes 206b and 206c, for example, may cause a portion of the electric field 208 to bypass the measurement circuitry associated with sense electrodes 204a and 204b, falsely indicating that the touch was positioned between sense electrodes 206a and 206b (as in FIG. 2B) rather than between sense electrodes 206b and 206c.

In certain embodiments, the above-described effect of fluid layer 210 may be affected by both (1) the level of various impurities (e.g., ions) in the fluid layer, and (2) the frequency of the drive signal applied to drive electrodes 204. For example, the permittivity of the fluid layer 210 (which may affect the degree to which the fluid layer 210 effectively extends the area of the touch, as described above) may be affected by the polarization of the fluid layer 210. Moreover, the polarization of the fluid layer 210 may be affected by the frequency of the applied drive signal as the ions present in the fluid layer 210 may take a finite amount of time to become polarized in the presence of the applied drive signal (e.g., for thin films of a weak ionic solution, the re-distribution of space charge may take several hundreds of nano-seconds to micro-seconds to complete). In other words, the shorter the duration of the applied drive signal (resulting from a drive signal having a higher frequency), the less time the ions of the fluid layer 210 have to become organized. Hence, the effective permittivity of the fluid layer 210 is lower.

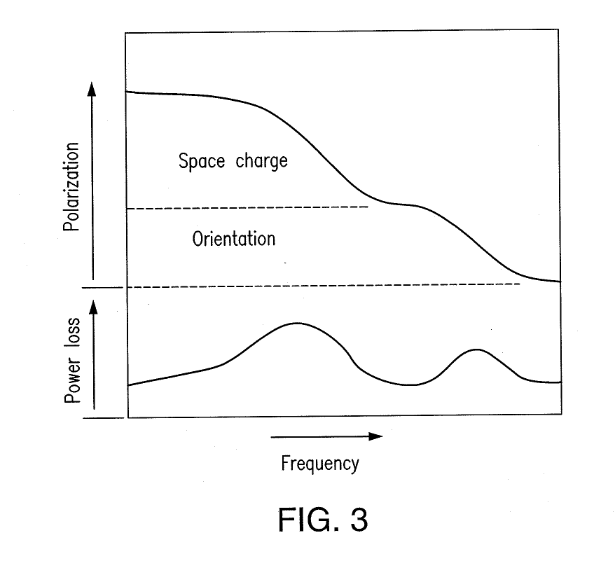

As one particular example, fluid layer 210 of may comprise a layer of water. For pure water, which has no space charge polarization, permittivity may be rather constant for applied frequencies in the region below ˜1 GHz. However, in most cases water, even partially deionized water is not completely ion-free. For example, tap water typically contains ions from soil (Na+, Ca2+), from pipes (Fe2+, Cu2+), and other sources. As a result, permittivity of tap water may be much higher than that of air (e.g., ε_{water}≈78*εₐᵢᵣ). In addition, as discussed above, permittivity be affected by polarization, and polarization may be affected by the frequency of an applied drive signal. FIG. 3 illustrates the dependence of the polarization of water on applied frequency. As illustrated, the polarization of water reduces with increasing frequency. Although the dependency of polarization on applied frequency has been illustrated and described for water for example purposes, the present disclosure contemplates that fluid layer 210 may be any fluid have dependence of polarization on applied frequency.

Conventional touch sensors may employ drive signals selected based on a number of factors (e.g., efficient power consumption), and may fall in the range of 25 kHz-500 kHz. In that frequency range, however, a fluid layer 210 (e.g., ionic water) may achieve sufficient polarization such that the permittivity of the fluid layer 210 adversely affects touch sensing (as described above with regard to FIG. 2C).

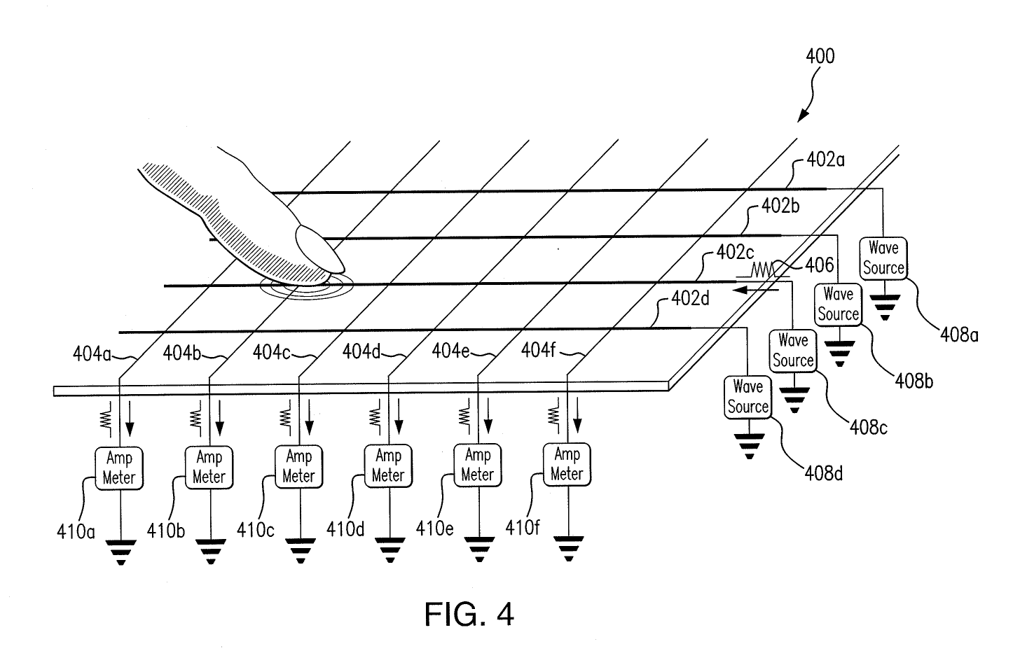

FIG. 4 illustrates an example touch sensor 400 having increased immunity to the presence of a fluid layer, according to certain embodiments of the present disclosure. Touch sensor 400 may be substantially similar to touch sensor 100 (described above with regard to FIG. 1), and is described in detail below.

Touch sensor 400 may include a number of drive electrodes 402 and a number of sense electrodes 404. A high-frequency drive signal 406 may be applied to each drive electrode 402 by a wave source 408. In addition, each sense electrode 404 may be coupled to an amplitude measurement circuit 410. Although a mutual capacitance touch sensor 400 having a particular arrangement of drive electrodes 402 and sense electrodes 404 is depicted an described, the present disclosure contemplates that the principles discussed below may apply to any suitable touch sensor (e.g., a self-capacitance touch sensor) having any suitable arrangement of any suitable electrodes.

Wave sources 408 may comprise any suitable component operable to generate bursts of drive signals 406 having a high base frequency component (e.g., in the range of ˜1 MHz-10 MHz). In certain embodiments, wave sources 408 may be variable such that drive signals 406 having a range of frequencies may be applied. In certain embodiments, the generated drive signals 406 may be a burst of sinusoid waveform, square waveform, a fast rising edge, or any other suitable signal having a high fundamental frequency (e.g., in the range of ˜1 MHz-10 MHz) or containing sufficient energy (e.g., in the range of ˜1 MHz-10 MHz). Although an individual wave source 408 is depicted as applying a drive signal 406 to each drive electrode 402, the present disclosure contemplates any suitable number of wave sources 408 for applying drive signals 406 to drive electrodes 402.

In the illustrated example, a drive signal 406 comprising a burst of sinusoid signal is applied to drive electrode 402c, and the signal is then coupled on every sense electrode 404 via the capacitors between the drive electrodes 402 and sense electrodes 404. Measurement circuits 410 (e.g., an amp meter or any other suitable measurement circuitry) coupled to each sense electrode 404 measure the signals transferred to the sense electrodes 404. As shown in this example, the signal at sense electrode 404b is attenuated due to the finger touch on the node at the intersection of drive electrode 402c and sense electrode 404b. As described above, if the attenuated signal (which may be measured in either voltage or current form) differs from an average baseline measurement by more than a threshold amount, touch sensor 400 (and/or a controller associated with touch sensor 400) may determine the presence of a touch at the intersection of drive electrode 402c and sense electrode 404b.

Because wave sources 408 may be operable to supply high-frequency drive signals 406 (e.g., in the range of ˜1 MHz-10 MHz), touch sensor 400 may be configured to mitigate the effect of a fluid layer on the cover panel of touch sensor 400. As described above, the permittivity of a fluid layer may be affected by the frequency of the applied drive signal 406 (due to the finite amount of time required for polarization to occur in the fluid layer 210). Accordingly, a drive signal 406 may be selected such that it is sufficiently high to eliminate false touches while still accounting for other factors such as power consumption. In certain embodiments, a drive frequency 406 that does not completely eliminate the effect of a fluid layer may be selected. Rather than completely eliminating the effect of a fluid layer, the drive frequency may be sufficiently high such that the amount of attenuation due to the fluid layer, as measured by measurement circuits 410, is below the threshold amount of attenuation used by the touch sensor 400 to determine the presence of a touch. As just one example, a frequency of ˜4 MHz may be selected to reduce or eliminate the impact of a fluid layer comprising tap water.

Although this disclosure illustrates several configurations of touch sensors, these illustrations are not necessarily drawn to scale. Certain features have been exaggerated or enlarged for descriptive purposes. For example, in particular illustrations, the drive and sense electrodes may be enlarged in comparison to touch screen.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A touch sensitive device, comprising
a cover panel;
a plurality of drive electrodes positioned below the cover panel;
a plurality of sense electrodes positioned below the cover panel; and
a controller comprising:
a signal generator operable to supply a drive signal to a particular drive electrode of the plurality of drive electrodes; and
measurement circuits associated with each of the plurality of sense electrodes, each measurement circuit operable to generate a signal corresponding to the charge transfer between the particular drive electrode and a corresponding sense electrode;
wherein the drive signal has a frequency that reduces the charge transfer caused by a fluid layer located on the cover panel to an amount falling below a threshold corresponding to the point at which the controller determines that a touch is present.

2. The touch sensitive device of claim 1, wherein the sense electrodes are separated from the drive electrodes by a dielectric layer.

3. The touch sensitive device of claim 1, wherein:
the fluid layer comprises water; and
the drive signal has a frequency in the range of 3 MHz to 5 MHz.

4. The touch sensitive device of claim 1, wherein the drive signal comprises a sinusoidal waveform.

5. The touch sensitive device of claim 1, wherein the drive signal comprises a square waveform.

6. The touch sensitive device of claim 1, wherein the drive signal comprises a. waveform containing the frequency.

7. The touch sensitive device of claim 1, wherein the threshold comprises a minimum difference between a stored historical average value of the signal generated by the measurement circuit corresponding to a particular sense electrode and a current value of the signal generated by the measurement circuit corresponding to a particular sense electrode.

8. A touch sensitive device, comprising
a cover panel;
a plurality of electrodes positioned below the cover panel; and
a controller operable to supply a drive signal to a particular electrode of the plurality of electrodes, the drive signal having a frequency corresponding to a frequency-dependent permittivity of a particular fluid.

9. The touch sensitive device of claim 8, wherein the drive signal has a frequency in the range of 1 MHz to 10 MHz.

10. The touch sensitive device of claim 8, wherein:
the particular fluid comprises water; and
the drive signal has a frequency in the range of 3 MHz to 5 MHz.

11. The touch sensitive device of claim 8, wherein the drive signal comprises a sinusoidal waveform.

11. The touch sensitive device of claim 8, wherein the drive signal comprises a square waveform.

12. The touch sensitive device of claim 8, wherein the drive signal comprises a waveform containing the frequency.

13. A method, comprising
supplying a drive signal to a particular drive electrode of a plurality of drive electrodes of a touch sensitive device;
generating, using a measurement circuit associated with each of a plurality of sense electrodes of the touch sensitive device, a plurality of signals, each signal corresponding to the charge transfer between the particular drive electrode and one of the plurality of sense electrodes; and
determining if each of the plurality of exceeds a threshold value;
wherein the supplied drive signal has a frequency that reduces the charge transfer caused by a fluid layer located on a cover panel of a touch sensitive device to an amount less than the threshold.

14. The method of claim 13, wherein:
the fluid layer comprises water; and
the drive signal has a frequency in the range of 3 MHz to 5 MHz.

15. The method of claim 13, wherein the drive signal comprises a sinusoidal waveform.

16. The method of claim 13, wherein the drive signal comprises a square waveform.

17. The method of claim 13, wherein the drive signal comprises a waveform containing the frequency.

18. The method of claim 13, wherein the threshold comprises a minimum difference between a stored historical average value of the signal generated by the measurement circuit corresponding to a particular sense electrode and a current value of the signal generated by the measurement circuit corresponding to a particular sense electrode.
